(19) United States
(12) Patent Application Publication
(10) Pub. No.: US 2004/0037317 A1
(43) Pub. Date: Feb. 26, 2004

(54) Multimedia communications over power lines

(76) Inventors: Yeshayahu Zalitzky, Raanana (IT); Shmuel Goldfisher, Petah-Tikva (IL); Ofir Efrati, Raanana (IL)

Correspondence Address: William H Dippert, Reed Smith, 29th Floor, 599 Lexington Avenue, New York, NY, 10022-7650, US

(21) Appl. No.: 10/363,619

(22) PCT Filed: Sep. 16, 2001
(86) PCT No.: PCT/IL01/00872

(51) Int. Cl. H04J 3/16

(52) U.S. Cl. 370/466

(57) ABSTRACT

A method for communication includes establishing a data link between first and second transceivers (32,34) over an electric power line (24). A sequence of data packets is received for transmission over the data link, the sequence belonging to a session of a connectionless real-time network protocol. Responsive to a first packet in the sequence, a reliable connection channel for the session is established over the data link between the first and second transceivers. The packets in the sequence are transmitted from the first to the second transceiver over the reliable connection channel.

### CROSS-REFERENCE TO RELATED APPLICATIONS

This application claims the benefit of U.S. Provisional Patent Application No. 60/234,016, filed Sep. 20, 2000, which is incorporated herein by reference.

### FIELD OF THE INVENTION

The present invention relates generally to data communications, and specifically to video and voice communications over electric power lines.

### BACKGROUND OF THE INVENTION

Data communications using residential power lines are known in the art. An advantage of using the lines is that only peripheral infrastructure needs to be added to the existing power lines in order to transmit and receive the data communications. With appropriate modems, power lines can be used to carry all the types of data traffic that are currently carried on local area networks (LANs), wide area networks (WANs) and internets, including real-time voice and video. Among the disadvantages of using power lines are high attenuation and the high level of interference on the lines, such as voltage spikes and Gaussian noise. These characteristics impose limitations on the available bandwidth and reliability of power line communications, which should be taken into account in the data services that are offered over power line networks.

In packet networks such as the Internet, the Real-time Transport Protocol (RTP) is commonly used to carry real-time multimedia traffic, such as video and voice. This protocol is described by Shulzrinne et al., in “RTP: A Transport Protocol for Real-Time Applications,” published by the Network Working Group of the Internet Engineering Task Force (IETF) as Request for Comments (RFC) 1889 (1996), which is incorporated herein by reference. RFC 1889 specifies a format for RTP packets that includes a 12-byte RTP header and a 20-byte payload, which are carried together as the payload of a User Datagram Protocol/Internet Protocol (UDP/IP) data packet. The RTP header includes a sequence number and time stamp, which increase by steps from one packet to the next in a RTP stream, along with a fixed synchronization source identifier (SSRC) field. Most of the other fields and flags in the RTP header change rarely, if at all, in the course of a RTP session. RTP is connectionless, like UDP, in the sense that RTP packets are steamed continuously from the source to the destination, with no provision for verifying that the packets have reached their destination intact.

The high overhead of RTP packets is a cause for concern when multimedia traffic is to be carried over low-bandwidth networks. The RTP, UDP and IP headers of a single packet add up to 44 bytes (compared to the 20-byte payload). The data link header (such as Ethernet) and additional signaling used for telephony applications, can easily add another 40 bytes, leaving only 20% of the channel bandwidth for the actual data. In response to this concern, Casner et at. suggest a method for RTP header compression on a link-by-link basis in IETF RFC 2508, entitled “Compressing IP/UDP/RTP Headers for Low-Speed Serial Links” (1999), which is incorporated herein by reference. This method takes advantage of the fact that most of the fields in the IP, LTDP and RTP headers do not change at all during the RTP session, or change by an increment that is generally constant. On this basis, the IP/UDP/RTP header in most of the packets is compressed down to two bytes, or four bytes when UDP checksums are included.

### SUMMARY OF THE INVENTION

It is an object of some aspects of the present invention to provide methods and apparatus for multimedia communications over power line communication (PLC) networks.

It is a further object of some aspects of the present invention to provide methods and apparatus for efficient, reliable Voice over IP (VoIP) communications using PLC networks.

In preferred embodiments of the present invention, a communications system comprises a plurality of data transceivers coupled to a network of power lines, preferably supplying mains voltage. Typically, the transceivers include a concentrator, which connects the power line network to a data communication network trunk, and power line modems in subscriber premises, which link subscriber equipment in the premises to the concentrator via the power lines. The power line modems preferably include both computer data ports, to which a user may connect a computer for serial or parallel data transfer, and telephone ports, to which the user may connect a conventional telephone handset. The concentrator is connected via the data communication trunk to a telephony server system, which preferably includes a gateway to a public switched telephone network (PSTN). Users can thus send and receive telephone calls over the power lines by communicating through the concentrator with the telephony server, using either their telephone handsets or telephony applications on their computers.

The transceivers monitor the traffic that they are conveying in order to detect streams of voice or video traffic, preferably by detecting RTP packets. When either the concentrator or one of the subscriber modems detects such a stream, it signals the transceiver at the other end of the link to establish a RTP connection for carrying the traffic. The connection is assigned a short (preferably one byte) connection identifier. The connection context, comprising the RIP, UDP and IP parameters that do not vary from packet to packet in the stream, is stored at both ends of the link, indexed by the connection identifier. Subsequently, for the duration of the connection, the sending transceiver removes the IP/UDP/RTP packet headers and, as long as the header parameters have not changed, substitutes a brief header containing the connection identifier and a sequence number for detecting lost packets. Periodically, the receiving transceiver returns an acknowledgment packet to the sender, indicating the sequence number of the last packet that was received intact, and informing the sender of any lost or corrupted packets. In this way, the narrow bandwidth of the PLC network is used efficiently, by reducing substantially the overhead of voice and video streams. At the same time, the reliability of voice and video communications is enhanced by adding an acknowledgment mechanism that is absent in the connectionless protocols usually used for real-time communications.

There is therefore provided, in accordance with a preferred embodiment of the present invention, a method for communication, including:

establishing a data link between first and second transceivers over an electric power line;

receiving a sequence of data packets for transmission over the data link, the sequence belonging to a session of a connectionless real-time network protocol;

responsive to a first packet in the sequence, establishing a reliable connection channel for the session over the data link between the first and second transceivers; and

transmitting the packets in the sequence from the first to the second transceiver over the reliable connection channel.

Typically, the packets include header information, and transmitting the packets includes compressing the header information in the packets transmitted using the channel from the first to the second transceiver. Preferably, establishing the reliable connection channel includes storing context information with respect to the session at the first and second transceivers, and compressing the header information includes compressing the header information using the stored context information. Further preferably, storing the context information includes conveying the context information to the second transceiver along with a channel identifier in the first packet in the sequence, and compressing the header information includes inserting the channel identifier in the packets in the sequence following the first packet as a reference to the context information. Most preferably, the method includes reconstructing the compressed header information at the second transceiver using the stored context information referenced by the channel identifier. Additionally or alternatively, compressing the header information includes detecting changes in the header information in successive packets in the sequence, and encoding the changes.

Preferably, the method includes sending an acknowledgment from the second transceiver to the first transceiver responsive to at least some of the packets in the sequence transmitted by the first transceiver, thereby maintaining the reliable connection channel. Further preferably, establishing the reliable connection channel includes determining an acknowledgment interval that includes a given number of the packets, and sending the acknowledgment includes sending the acknowledgment every time the given number of packets has been received at the second transceiver. Most preferably, transmitting the packets includes adding an error detection code at the first transceiver to one of the packets in the acknowledgment interval, and sending the acknowledgment includes checking the error detection code at the second transceiver, and indicating a result of the checking in the positive or negative acknowledgment returned by the second transceiver.

Additionally or alternatively, transmitting the packets includes adding a channel sequence number to each of the packets, and sending the acknowledgment includes sending an indication from the second transceiver to the first transceiver when the channel sequence number of the packets received at the second transceiver deviates from a consecutive order.

Further additionally or alternatively, establishing the reliable connection channel includes sending a request from the first transceiver to the second transceiver to allocate a resource for the channel, and sending the acknowledgment includes indicating to the first transceiver in a negative acknowledgment that the second transceiver does not have the resource available to open the channel.

In a preferred embodiment, the first and second transceivers include a subscriber transceiver in a subscriber premises and a concentrator, and wherein the electric power fine is a part of a mains voltage power line network to which the subscriber transceiver and the concentrator are connected. Typically, the subscriber transceiver is one of a plurality of such transceivers in multiple, respective subscriber premises connected to the power line network, and the concentrator is coupled to link the plurality of the transceivers to a packet communication trunk. Preferably, receiving the sequence of the data packets includes receiving a real-time data flow to be conveyed between the subscriber premises and a network server via the packet communication trunk. Most preferably, receiving the real-time data flow includes receiving telephony data, and the network server includes a telephony gateway, which is coupled to a public switched telephone network (PSTN). In a further preferred embodiment, receiving the telephony data includes receiving data associated with a telephone call placed from one of the multiple subscriber premises connected to the power line network to another of the multiple subscriber premises, and the telephony gateway is further configured to serve as a virtual exchange, so as to convey the telephony data from the one of the subscriber premises to the other without sending the data through the PSTN.

In another preferred embodiment, receiving the sequence of the data packets includes receiving real-time multimedia data, preferably video data and/or voice data. Most preferably, receiving the voice data includes coupling a telephone handset to one of the transceivers, and conveying the voice data as an analog audio signal between the one of the transceivers and the telephone handset. Alternatively, receiving the voice data includes coupling a personal computer to one of the transceivers, and conveying the data packets between the one of the transceivers and a voice application on the personal computer.

Preferably, receiving the sequence of the data packets includes receiving the packets in accordance with a Real-time Transfer Protocol (RTP).

There is also provided, in accordance with a preferred embodiment of the present invention, communication apparatus, including a first data transceiver, which is configured to establish a data link with a second data transceiver over an electric power line, such that upon receiving a sequence of data packets for transmission over the data link, the sequence belonging to a session of a connectionless real-time network protocol, the first data transceiver is adapted, responsive to a first packet in the sequence, to establish a reliable connection channel for the session over the data link with the second transceiver and to transmit the packets in the sequence to the second transceiver over the reliable connection channel.

In a preferred embodiment, the sequence of the data packets includes real-time multimedia data, including voice data, and the first transceiver includes a telephone adapter, which is configured to exchange the voice data in the form of analog audio signals to and from a telephone handset. Alternatively or additionally, the first transceiver includes a computer communication port, which is configured to exchange the voice data in the form of voice packets to and from a voice application on the personal computer.

Preferably, the first transceiver includes one of a subscriber transceiver in a subscriber premises, and a concentrator, and the electric power line is a part of a mains voltage power line network to which the subscriber transceiver and the concentrator are connected.

There is additionally provided, in accordance with a preferred embodiment of the present invention, communication apparatus, including:

a subscriber transceiver, for deployment in a subscriber premises, the subscriber transceiver being adapted to be coupled to an electric power line belonging to a mains voltage power line network; and

a concentrator, coupled to the power line network so as to convey data between the subscriber transceiver and a packet communication trunk the subscriber transceiver and the concentrator being configured to establish a data link therebetween over the electric power line, such that upon receiving a sequence of data packets for transmission over the data link, the sequence belonging to a session of a connectionless real-time network protocol, the subscriber transceiver and the concentrator are adapted, responsive to a first packet in the sequence, to establish a reliable connection channel for the session over the data link and to transmit the packets in the sequence from one to another over the reliable connection channel.

The present invention will be more fully understood from the following detailed description of the preferred embodiments thereof taken together with the drawings in which:

### BRIEF DESCRIPTION OF THE DRAWINGS

FIG. 1 is a block diagram that schematically illustrates a system for power line communications (PLC), in accordance with a preferred embodiment of the present invention;

FIG. 2 is a block diagram that schematically shows details of a power line data transceiver, in accordance with a preferred embodiment of the present invention;

FIG. 3 is a block diagram that schematically shows communication protocols used to carry voice traffic in a PLC system, in accordance with a preferred embodiment of the present invention;

FIG. 4 is a table that schematically illustrates a packet header used in real-time network communications;

FIG. 5 is a flow chart that schematically illustrates a method for compressing packet headers in a PLC system, in accordance with a preferred embodiment of the present invention;

FIG. 6 is a flow chart that schematically illustrates a method for decompressing compressed packet headers, in accordance with a preferred embodiment of the present invention;

FIGS. 7A-7D are tables that schematically illustrate packets headers used in the header compression and decompression methods of FIGS. 5 and 6; and

FIG. 8 is a flow chart that schematically illustrates details of a method for packet header compression, in accordance with a preferred embodiment of the present invention.

### DETAILED DESCRIPTION OF PREFERRED EMBODIMENTS

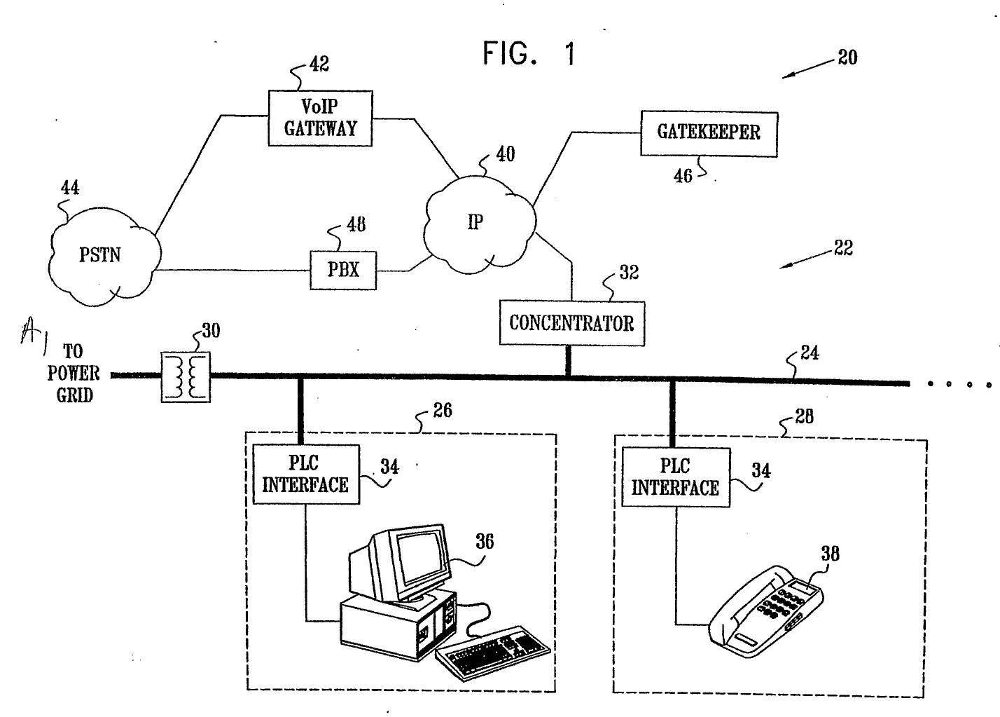

FIG. 1 is a block diagram that schematically illustrates a communication system 20, in accordance with a preferred embodiment of the present invention. System 20 is built around a power line communication (PLC) network 22, which uses a power line 24 to carry digital packet communications to and from a plurality of subscriber premises 26, 28, . . . . Power line 24 preferably comprises a network of power lines supplying mains voltage, typically at a level of 120 VAC or 240 VAC, which share a common step-own transformer 30, connecting power line 24 to the medium/high-voltage power grid. It will be appreciated, however, that the scope of the present invention is not limited to a specific level or type of line voltage.

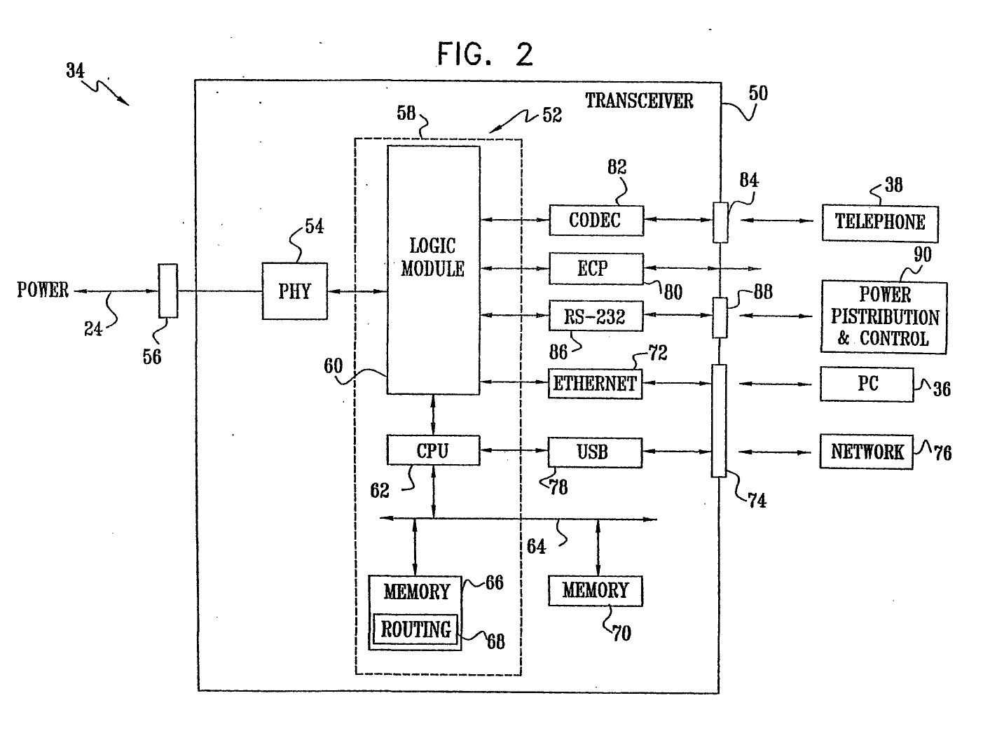

Premises 26, 28, . . . , typically comprise homes and/or offices and/or other receiving units of the electric power. Each premises is served by a transceiver 34, which acts as an interface between power line 24 and subscriber equipment, such as a personal computer 36 and a telephone 38. Transceiver 34 is described in greater detail below with reference to FIG. 2. One or more master transceivers, referred to herein as a concentrator 32, couples power line 24 to a packet network trunk 40. The trunk typically has the form of a wide area network (WAN) maintained by an electric utility company to carry communications between the concentrators on different low-voltage segments of the power system such as on line 24.

Trunk 40 is typically coupled to a variety of different public communication networks, including the Internet and a public switched telephone network (PSTN) 44. This connection enables subscribers in premises 26, 28, . . . , to place and receive telephone calls over PLC network 22. Preferably, the calls are carried between transceivers 34 and a telephony gateway 42 in the form of packetized voice and signaling data, typically using Internet Protocol (IP) communications on both power line 24 and trunk 40. Gateway 42 interfaces with PSTN 44, converting IP packets to PSTN audio and signaling, and vice versa, as is known in the art Signaling for calls on PLC network 22 is routed to a gatekeeper 46, which is a server responsible for tasks such as assigning an IP address to the calling party, verifying that the called party is available and that the call is authorized, and monitoring calls for billing purposes. A network management system (not shown) coupled to trunk 40 is responsible for allocating bandwidth to calls depending on the load on PLC network 22. Preferably, the level of compression of the audio data carried on network 22 and trunk 40 is variable, under control of the network management system, in response to variations in the network load.

As an addition or alternative to gateway 42, telephone calls to and from transceivers 34 may be handled through a virtual private branch exchange (PBX) 48, coupled to trunk 40. PBX 48 is preferably implemented as a special telephony application rag on a general-purpose network server. In addition to interfacing with PSTN 44, PBX 48 acts as a switch in a private telephone network serving customers of the electrical utility company who use PLC network 22 for their telephone calls. PBX 48 routes local telephone calls between such customers through trunk 40 and the subscribers' local power lines 24, without using PSTN 44. This-feature of the PBX allows the utility company to offer local telephone service at reduced rates, relative to the PSTN. Outgoing and incoming calls involving telephone subscribers outside the local PLC network are routed by PBX 48 to and from PSTN 44, in a manner similar to VoIP gateway 42.

Voice telephony is thus carried over PLC network 22 in much the same way as other types of packet data, but with a few important differences. One difference is that the telephony packets are preferably assigned a high level of priority, relative to other types of traffic, so as to provide adequate quality of service (QoS) for real-time voice. In addition, the voice packet headers are compressed to conserve bandwidth on the PLC network, as described in detail hereinbelow. Other real-time multimedia traffic, such as real-time video, which is typically fed to PLC network 22 from the Internet and from entertainment networks, is preferably treated in a similar fashion to voice, with high priority and header compression. Therefore, although preferred embodiments are described herein primarily with reference to telephony applications, it will be understood that the principles of the present invention are similarly applicable to other types of real-time data traffic.

FIG. 2 is a block diagram that schematically shows details of one of subscriber premises transceivers 34, in accordance with a preferred embodiment of the present invention. The design and operation of transceiver 34 are described in greater detail in PCT Patent Application PCT/IL01/00745, filed Aug. 12, 2001, which is assigned to the assignee of the present patent application and whose disclosure is incorporated herein by reference. Transceiver 34 comprises a multi-function modem unit 50, which acts as an interface between power line 24 and low-voltage data information lines. Modules of unit 50 act as data-conversion circuitry, accepting incoming data from elements such as a network or a telephone and converting the data to signals compatible with the power line, as well as performing the reverse operation. Certain modules also act as a data communication controller 52, and as level-setting circuitry for transmission of the data.

Transceiver 34 is preferably coupled to line 24 by an industry-standard power socket 56. A physical interface (PHY) module 54 acts as a full-duplex converter between serial data signals of a data link unit 58 and power line signals of power line 24. A logic module 60 communicates with a central processing unit (CPU module 62, which is used to operate and control other modules comprised in the transceiver. In addition to acting as an overall controller for transceiver 34, CPU 62 is utilized to convert data received by and transmitted to other modules of the transceiver, as well as to control routing of communications between transceiver 34 and other elements of PLC network 22. CPU 62 preferably operates using a volatile memory 66 such as a random access memory (RAM), containing a routing table 68, and a non-volatile memory 70, such as a flash memory. Memories 66 and 70 are coupled to CPU 62 by an internal bus line 64.

CPU 62 communicates with the other modules of transceiver 32 via logic module 60, which acts as a multiplexer, transferring data to and from subscriber equipment interface modules 72, 78, 80, 82 and 86, whose functions are described below:

CODEC module 82, preferably an industry-standard CODEC, transmits and receives standard telephone signals via an industry-standard connector 84 to and from telephone 38. The CODEC converts the analog telephone signals to a suitable digital form, such as the H.323 format promulgated by the International Telecommunications Union (ITU), and vice versa, in a full-duplex manner.

ECP module 80 communicates with personal computer 36 via an industry-standard parallel port of the computer.

RS-232 module 86 provides industry-standard serial communication, via a connector 128.

Ethernet module 72 provides packet data communications, using a standard protocol such as 10BaseT, via a connector 74. Computer 36 may connect to module 72 either directly via connector 74 or via a LAN 76.

Alternatively or additionally, Universal Serial Bus (USB) module 78, which is preferably coupled directly to CPU 62, communicates with a USB host via connector 74.

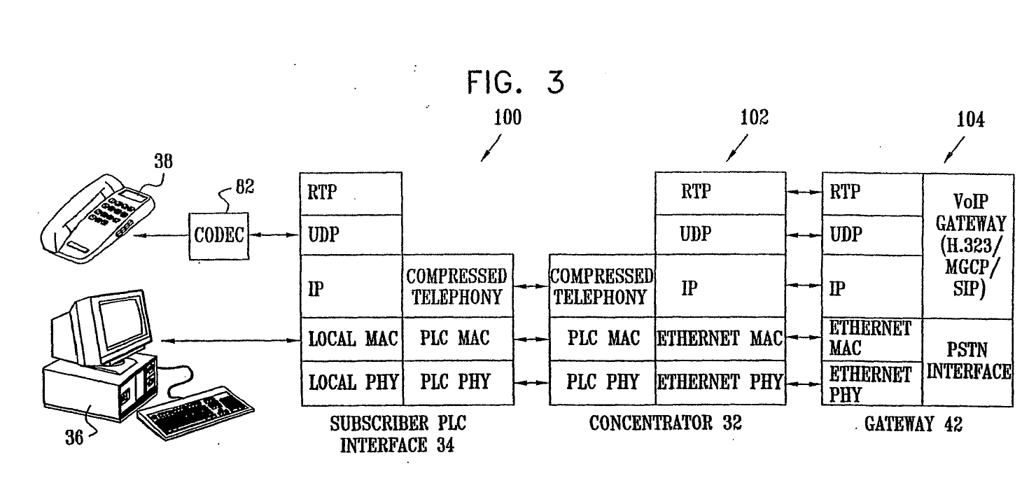

FIG. 3 is a block diagram that schematically illustrates protocols used in voice communications over PLC network 22, in accordance with a preferred embodiment of the present invention. The communications are shown, by way of example, as taking place between either personal computer 36 or telephone 38 and VoIP gateway 42, via subscriber PLC transceiver 34 and concentrator 32. The communications are generated at the subscriber end as a RTP packet stream, which is preferably produced by a suitable IP telephony application running on computer 36. Alternatively, the subscriber may use telephone 38 to generate audio and signaling. In this case, CODEC module 82 converts the telephone output to standard digital form, and data link unit 58 generates the RTP header data, as well as processing the RTP packets retired from the party at the other end of the telephone call.

Thus, a subscriber-end protocol stack 100 shown in FIG. 3 comprises RTP, UDP and IP layers on the subscriber side, running over local media access control (MAC) and physical layer communications provide by the appropriate subscriber equipment interfaces, such as Ethernet interface module 72. When CPU 62 generates or detects an outgoing RTP/UDP/IP packet stream, it preferably establishes a point-to-point connection between transceiver 34 and concentrator 32 for the purpose of carrying the stream, and then compresses the packet headers in the RTP/UDP/IP session, as described in detail hereinbelow. Concentrator 32 preferably functions in like manner with respect to incoming packet streams from trunk 40. The RTP, UDP and IP layers are then carried on power line 24 between subscriber transceiver 34 and concentrator 32 by a special, compressed telephony layer, over the PLC MAC and physical layers generated by data link unit 58 and PHY module 54. The MAC layer protocol is described in detail in the above-mentioned PCT patent application.

In a concentrator stack 102, running on concentrator 32, the compressed telephony layer for outgoing calls is decompressed to recover the original RTP, UDP and IP headers. Conversely, incoming RTP/UDP/IP headers are compressed for transmission to transceiver 34. The RTP/UDP/IP voice packets may also be carried over packet trunk 40 in compressed form, and decompressed at gateway 42 or at another point along the way. The MAC and PHY layers on the trunk side of concentrator 32 are typically those of a standard data link protocol used on the packet network to which trunk 40 belongs, preferably an Ethernet protocol.

A VoIP gateway stack 104 is used by gateway 42 to interface with PSTN 44. The gateway stack is preferably built on protocols known in the VoIP art, including H.323, along with the Session Initiation Protocol (SIP) for call signaling and the Media Gateway Control Protocol (MGCP) for handling audio data flow.

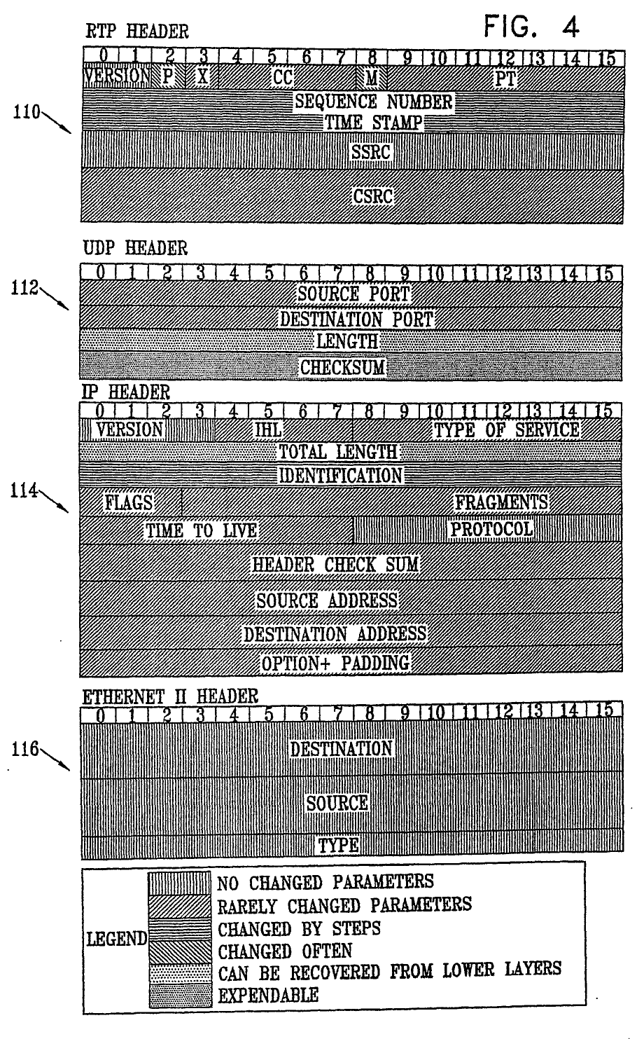

FIG. 4 is a table that schematically illustrates fields in the RTP/UDP/IP/Ethernet header structure, which are used in the compression scheme described below. As indicated by a legend at the bottom of the figure, the fields are coded to show which typically change in the course of a RTP session, and which do not. Some of the fields are shown as being optional or “expendable,” indicating that they can be deleted at one end of the session connection and recovered if necessary at the other end. Further information regarding the header fields is provided in the above-mentioned RFC 1889 and RFC 2508.

In a RTP header 110, the version and SSRC numbers should remain constant for the duration of a session. The P, X, CC, M and PT fields in the header change occasionally at most, as does the contributing source identifier (CSRC). The packet sequence number and time stamp fields change from one packet to the next, typically by a constant increment. The expected increment of tile packet sequence number is 1, while that of the time stamp depends on the CODEC being used. (For example, for G.729, the typical time stamp increment is 160.)

In a UDP header 112, the UDP source port and destination port do not usually change in the course of a session, although they may occasionally do so. By convention, even-numbered UDP ports are used for RTP traffic. The UDP segment length is generally redundant, since it can be recovered from packet parameters of lower-layer protocols. Although UDP packets conventionally carry a checksum, this field can also be omitted in some or all of the packets.

In an IP header 114, most of the fields also change rarely if at all in the course of a RTP session. As in the case of the UDP length, the IP total length can be deleted and recovered subsequently from lower-layer protocol information. The IP packet identification (ID) is normally incremented by one for each new packet.

Finally, in an Ethernet header 116, the source and destination information, identifying the transceivers at the ends of the link must remain constant during any given session.

Based on the information in FIG. 4, it is evident that any given RTP session between a subscriber premises transceiver 34 and concentrator 32 can be represented by context information that changes little if at all in the course of a session. As sessions are created, each session is assigned a unique context ID (CID), or channel number. The session context is stored in a pool in memory by both the transceiver and the concentrator (for example, in memory 66, FIG. 2). The context entries are preferably stored in the memory as a linked list, referenced by a hashing function based on a certain number of the least significant bits (LSB) of the RTP SSRC and the IP destination address for the respective sessions. Table I below shows a preferred structure for the memory pool context entries.

TABLE I
SESSION CONTEXT PARAMETERS

| | | Size |
|---|---|---|
| Category | fleld | (bits) |
| CID | Context ID (channel number) | 8 |
| Counters | Number of CONTEXT_STATE (ACK or NACK) | 8 |
| | paokets received (see description below) | |
| | Total RIP packets received | 16 |
| Seq | Sequenlial number of compressed packet | 4 |
| State | Channel state (active, inactive, pending - see below) | 4 |
| Time_tag | Last update to this channel - channel is cleared after | 32 |
| | timeout occurs with no update | |
| RTP | P bit | 1 |
| | X bit | 1 |
| | CC | 4 |
| | Mbit | 1 |
| | Payload type | 7 |
| | Previous sequence number | 16 |
| | Previous timestamp | 32 |
| | SSRC | 32 |
| | CSRC (pointer to list) | 16 |
| UDP | Source port | 16 |
| | Destination port | 16 |
| IP | IHL | 4 |
| | Type of service | 8 |
| | Previous liD | 16 |
| | Flags | 3 |
| | Fragments | 13 |
| | Time to live | 8 |
| | Source address | 32 |
| | Destination address | 32 |
| | Options + padding | 32 |
| Ethernet | Source MAC address | 48 |
| | Destination MAC address | 48 |
| ACKs | Last seq number acknowledged | 4 |
| | Last CRC sent (on seq number) | 16 |
| D | Debug state | 1 |
| Next_entry | Link to next entry or end of list | 15 |

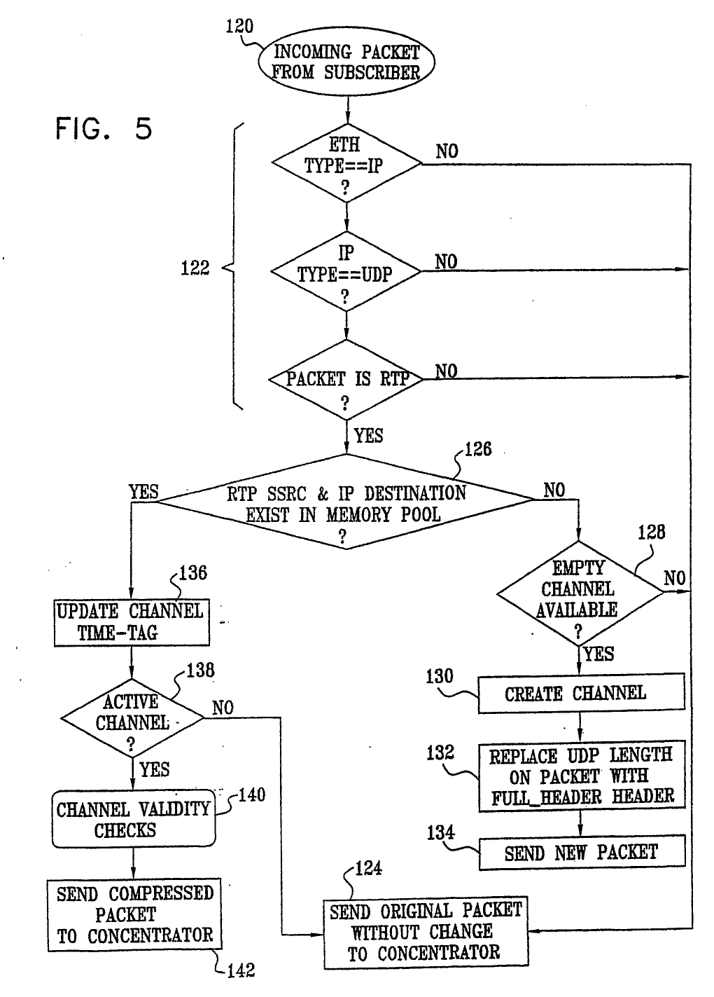

FIG. 5 is a flow chart that schematically illustrates a method for processing an outgoing packet stream at transceiver 34, for the purpose of RTP header compression, in accordance with a preferred embodiment of the present invention. For the sake of clarity, the process is described from the perspective of the subscriber-side transceiver. It will be understood, however, that a similar process is typically applied to incoming packet streams by concentrator 32. Each packet coming into transceiver 34 from the subscriber equipment is processed by data link unit 58, at a packet preparation step 120. The data link unit examines each packet, at a packet examination step 122, to determine whether it is a RTP/UDP/IP packet, making it a candidate for RTP header compression. Non-RTP packets are sent to concentrator 32 without header compression, at a packet sending step 124.

When unit 58 determines that it has received a candidate packet for header compression, it checks the RTP SSRC and IP destination fields in the packet header against its memory pool (using the above-mentioned hashing function) to determine whether the packet belongs to a session, or channel, that has already been opened, at a context checking step 126. If such a session is not found, unit 58 next checks to determine whether it has sufficient memory resources available to open a new session, at a channel availability step 128. If there is no channel available, the packet is sent without compression, at step 124. Similarly, unit 58 should also check whether the RIP version is the correct one, and whether the RTP payload type is known If the P bit is set in the RTP header, the last octet of the packet must contain a valid octet count (less than the total packet length minus the header size). If any of these conditions are not satisfied, a channel should not be opened, and the packet should instead be sent without compression at step 124.

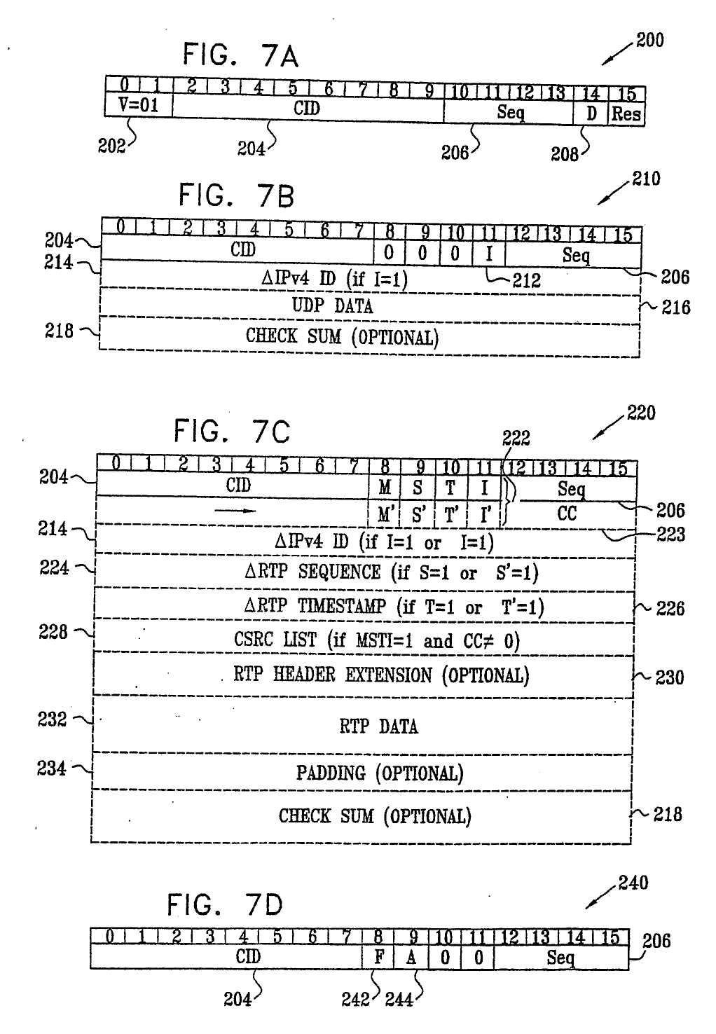

When a new channel is available, data link unit 58 creates the channel in its memory pool, and assigns it a context ID (CID), at a channel creation step 130. The memory pool now includes the full packet context, as specified in Table I above. To notify concentrator 32 that a new channel has been opened, unit 58 replaces the UDP length field in the UDP header (FIG. 4) with a FULL_HEADER identifier field, at a header replacement step 132. The FULL_HEADER identifier, shown below in FIG. 7A, includes the assigned CID and the staring link sequence number (Seq). The modified packet is then sent on to concentrator 32, at a new packet transmission step 134. Upon reading the packet header with the FULL_HEADER identifier, the concentrator opens the channel in its own memory pool, using the CID, Seq and context information in the packet header, and is now ready to receive compressed packets.

When at step 126, data link unit 58 determines that the current RTP packet belongs to an existing session already opened in the memory pool, it updates the corresponding channel time_tag field, at a timer update step 136. It then checks the channel state (see Table I) to determine whether or not the channel is active, at an activity checking step 138. A channel is deemed inactive when the concentrator has signaled, using the acknowledgment mechanism described below, that it has received packets with errors or that packets have been lost on this channel. In such as case, the original packet is sent without header compression to concentrator 124. A channel may be deemed pending if, upon an attempt by data link unit 58 to create the channel concentrator 32 responds that its memory pool is full. Packets are likewise sent over pending channels without header compression. Such channels are ultimately erased from the memory pool of data link unit 58 by an aging mechanism if resources are not freed so that the pending channels can become active.

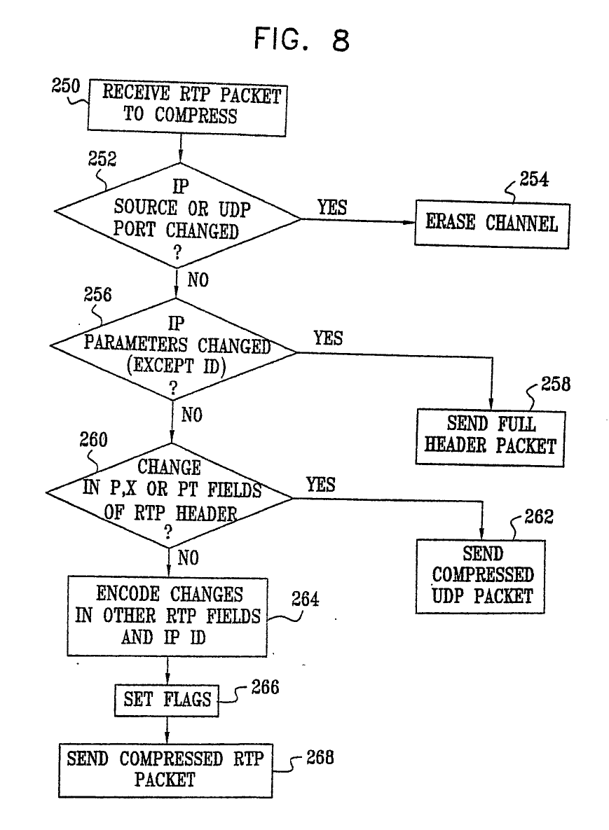

When the RTP packet is found at step 138 to belong to an active channel, data link unit 58 performs validity checks to ascertain that the channel is still valid, at a validity checking step 140. The packet header is then compressed, and the compressed packet is sent to concentrator 32, at a compressed transmission step 142. Details of steps 140 and 142 are described below with reference to FIG. 8.

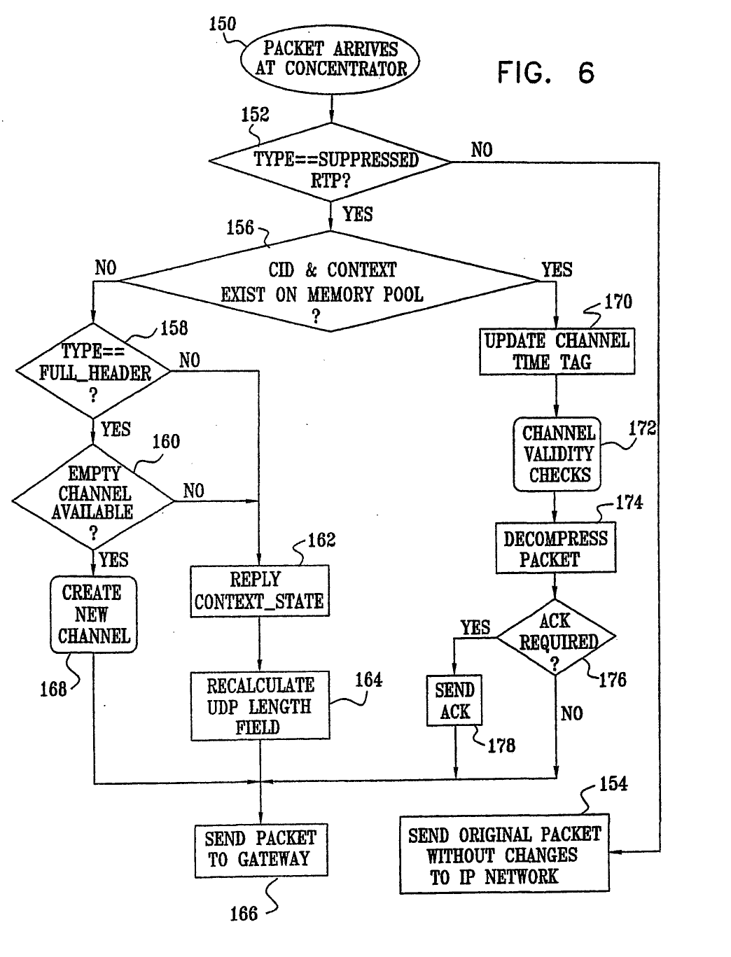

FIG. 6 is a flow chart that schematically illustrates processing of compressed packets received by concentrator 32 from transceiver 34, in accordance with a preferred embodiment of the present invention. (As in the case of the method of FIG. 5, this same method is carried out by data link unit 58 of transceiver 34 when it receives packets from the concentrator.) Upon arrival of each packet from transceiver 34, at a packet arrival step 150, concentrator 32 checks the packet header. By examining the packet header fields, the concentrator is able to determine whether the packet belongs to a known RTP header compression type, at a suppression determination step 152. If not, the concentrator simply sends the packet on to IP trunk 40 without changes, at a packet pass-on step 154, except for the necessary changes to Ethernet header 116 (FIG. 4) that are mandated by standard protocols.

When concentrator 32 detects a RTP packet with a suppressed header type, it next checks the context ID (CID) in the packet header to determine whether his channel already exists in its memory pool, at a channel checking step 156. The memory pool of the concentrator (at the receiving end of the RTP session) is nearly the same as that shown above for the sending end in Table I. One difference is that the memory pool at the receiving end contains the MAC address of the packet source (transceiver 34) on PLC network 22. Another is that the “counters” category contains counts of the number of acknowledgment packets sent and the number of RTP packets received on the channel. Furthermore, channels at the receiving end of the connection can have only two states: active and inactive.

If the CID of the packet does not exist in the memory pool at concentrator 32, the concentrator checks the packet to verify that it is a FULL_HEADER type, at a header checking step 158. As noted above, this is the packet type that transceiver 34 sends to initiate opening of a new channel. If this is not the expected FULL_HEADER type of packet, concentrator 32 sends a CONTEXT_STATE packet back to transceiver 34, indicating that it was unable to forward the packet, at a context reply step 162. (The CONTEXT_STATE format, shown in FIG. 7D, is used by the recipient of compressed packets to signal acknowledgment—ACK—or negative acknowledgment—NACK—of the packets, as described below.) This situation may arise, for example, when the transceiver reboots itself in the middle of the transmission sequence, or when the first FULL_HEADER packet is lost in transit to the concentrator. In such cases, the transceiver and concentrator must resynchronize before they can resume normal communications.

If the packet is a FULL_HEADER type compressed packet, concentrator 32 next checks to determine whether it has a new channel available in its memory pool, at an empty channel checking step 160. If too many of the transceivers in subscriber premises 26, 28, . . . , are busy making telephone calls over PLC network 22, the concentrator may temporarily run out of channels. In this case, too, the concentrator sends a CONTEXT_STATE packet back to transceiver 34, indicating that it is out of free channels, at a reply step 162. Despite the negative response, however, the concentrator is still able to reconstruct the original, standard RTP/UDP/IP header by recalculating the UDP length, at a length recalculation step 164, and reinserting the length into the UDP header of the packet in place of the FULL_HEADER field tat was substituted by transceiver 34. The concentrator then sends the reconstructed packet out over IP trunk 40.

Returning to step 156, if concentrator 32 finds that the CID in the packet header exists in its own memory pool, it updates the time_tag in the corresponding channel context, at a timer updating step 170. It checks the source MAC address of the packet against he context, to ensure that the packet is valid, at a validity checking step 172. It also checks the sequence number (Seq) of the packet to ensure that it is exactly one greater than the preceding packet received on this channel. If so, concentrator 32 can proceed to decompress the packet and reconstruct the RTP/UDP/IP header, at a decompression step 174. Details of the decompression process are described hereinbelow. If a packet is missed, the channel becomes inactive, and the packet cannot be decompressed or sent.

In order to maintain synchronization between the sender and receiver of compressed packets, the receiver is required to acknowledge the compressed packets it has received, at an ACK requirement step 176. For this purpose, a time window, T, is defined at both the sending and receiving ends, such that every T compressed packets an acknowledgment protocol is carried out. The sender preferably saves the sequence number and appends a cyclic redundancy code (CRC) value to the packet whose acknowledgment is required. The receiver recomputes the CRC and compares it to the appended value. If the CRC values match, the receiver returns an ACK packet (i.e., a CONTEXT_STATE packet) with the sequence number to the sender, at an acknowledgment step 178. If there is a mismatch of the CRC values, the receiver returns a CONTEXT_STATE NACK packet. In an optional debugging mode, the receiver may check the CRC of every packet, and send a NACK response to the sender for any packet in which the CRC check fails. When the sender receives the ACK response from the receiver, it checks the sequence number and CRC value against the values it has saved, and clears the values if they match. If the sender does not receive the proper ACK, it sends a FULL_HEADER packet in order to refresh the channel context.

When concentrator 32 determines at step 172 that a packet has been lost, it must send a NACK to transceiver 34, in the form of a CONTEXT_STATE packet. The NACK packet reports the sequence number of the last packet received and requests transmission of a FULL_HEADER packet to update the channel context.

FIGS. 7A-7D are tables that schematically illustrates the types of packets sent between transceiver 34 and concentrator 32 in carrying out the compression and decompression protocols of FIGS. 5 and 6. The packet types generally follow the definitions in the above-mentioned RFC 2508, with changes appropriate to the specific constraints and requirements of PLC network 22. FIG. 7A shows a FULL_HEADER field 200 that is inserted in place of the length field in the UDP header (FIG. 4) of a full RTP/UDP/IP packet header. Field 200 includes a version number 202 (for example, “01”), context ID (CD) 204, and a current sequence number (Seq) 206. An optional “D” bit invokes the above-mentioned debug mode, in which a CRC is added by the sender to each of the compressed packets and is checked by the receiver.

FIG. 7B shows a COMPRESSED_UDP packet 210, which is sent by the transmitter when the P, X or PT field in the RTP header has changed. When such a change occurs, additional information must be conveyed to the receiver in order to update the channel context, and this information is conveyed by the COMPRESSED_UDP packet. The packet header includes CID 204 and Seq 206, as well as an “I” flag 212. This flag is set if the IP version 4 (IPv4) ID has changed by an amount other than one from the preceding packet to this one. If “I” is set, packet 210 includes a ΔIP field 214 that gives the actual ID change. Preferably, the change in ID is encoded using a Huffman encoding scheme, as is known in the art, so that common values of the ID change (typically in the range 0:127) are encoded as a single byte, while less common values take two or three bytes. A scheme of this sort is suggested in RFC 2508. No further encoding of the IP or UDP header is required. (If it were, a FULL_HEADER packet would be sent.) The packet next includes UDP data 216, which comprises the full RTP header and payload, followed by an optional checksum 218.

FIG. 7C shows a COMPRESSED_RTP packet 220, which is sent when the changes in the RTP/UDP/IP header are minimal. Following CID 204, the packet includes compression flags 222, with the following meanings:

“M” indicates that the “M” bit in the RTP header has changed.

“S” indicates that the RTP sequence number has changed by an amount different from the usual sequence increment in this case, a ΔRTP sequence field 224 contains the actual change in the sequence number, preferably using a Huffman encoding scheme as described above.

“T” indicates the RTP timestamp has changed by an amount different from the usual time increment In this case, a ΔRTI timestamp field 226 contains the actual change in the timestamp, preferably using a Huffman encoding scheme as described above.

“I” indicates that the IPv4 ID has changed by an amount different from one, with its actual change given by field 214.

When all of M, S, T and I are set, and a CC field 223 is not equal to zero, a CSRC list 228 is included in packet 220, with a length given by the value of CC. In this case, the values M=S=T=I=1 are artificial, to signal that the packet includes the CSRC list, and the roles of flags M, S, T and I are respectively assumed by flags M′, S′, T′ and I′.

If the “X” bit is set in the RTP header, the header extension is contained in a RTP header extension field 230. The remainder of the packet contains RTP data 232, followed by optional padding 234 (if the “P” bit is set) and checksum 218.

FIG. 7D shows a CONTEXT_STATE packet 240, used for the ACK and NACK functions described above. An “F” bit 242 is set by the receiver to indicate that its memory pool is full, so that a new channel that the transmitter has asked to open must remain in the pending state. An “A” bit 244 is set to indicate a positive acknowledgment (ACK), and is reset for NACK. Seq field 206 indicates the sequence number of the last packet that the receiver was able to read on this channel. The use of the CONTEXT_STATE packet in this manner (which differs from that proposed in RFC 2508), with a predefined window for positive ACK response by the receiver, turns the unidirectional, connectionless RTP/UDP packet stream into a full-duplex, connection-oriented protocol within PLC network 22, while at the same time saving substantial bandwidth. Both of these features are particularly important when working over power line 24, with its high noise level and low bandwidth.

FIG. 8 is a flow chart that schematically illustrates the use of packet formats 200, 210 and 220 in sending compressed RTP packets over PLC network 22, in accordance with a preferred embodiment of the present invention. The steps of the method shown in FIG. 8 correspond roughly to validity checking step 140 and compressed transmission step 142 in FIG. 5, after transceiver 34 has ascertained that the RTP packet in question belongs to an active channel in its memory pool.

The method of FIG. 8 is initiated when transceiver 32 receives a RTP packet to compress on a valid, active channel, at a packet reception step 250. The transceiver first checks fields that are supposed to remain constant over an entire RTP session: the IP source address and the UDP ports, at a constant field checking step 252. If any of these parameters have changed in the current packet, relative to the channel context in the memory pool, the current channel is erased, at an erasure step 254. A new channel may be created in its place with the new parameters.

Next, the transceiver checks whether any of the other IP parameters have changed, at an IP checking step 256. These fields are also generally constant during a session, with the exception of the IP ID field, which is incremented from packet to packet. If any of the parameters have changed, other than the IP ID increment, the transceiver sends a FULL_HEADER packet, at a full transmission step 258. This packet refreshes the contents of the channel context, but without creating a new channel.

If the packet passes step 256 successfully, the transceiver checks to determine whether any of the P, X or PT fields of the RTP header have changed relative to the channel context, at a RTP parameters checking step 260. As noted above, if any of these fields have changed, compressed UDP packet 220 is sent, at a compressed UDP sending step 262. If the IP ID increment has changed, the packet will also include the appropriate ΔIPv4 ID field 214.

If none of these RTP fields have changed, the transceiver checks the other RTP header fields, as well as the IP ID field, in order to encode any changes in the fields, at an RTP encoding step 264. These changes include changes in the fields themselves, for the M and CSRC fields, as well as changes in the increment of the sequence number, timestamp and IP ID fields. Any changes are encoded in the manner described above, and the corresponding flags 222 and CC field 223 are set accordingly, at a flag raising step 266. Most of the time, fields 214, 224, 226 and 228 are empty, so that flags 222 and field 223 are zero. The packet can now be sent to the concentrator 32.

In order to monitor decompression processing activities, concentrator 32 preferably maintains the following counters:

Global counters—

Total RTP packets reconstructed.

Total synchronizing FULL_HEADER) packets received.

Total semi-compressed packets received (COMPRESSED_UDP).

Total fully-compressed packets received (COMPRESSED_RTP).

Total synchronizing packets sent (CONTEXT_STATE with F bit off).

Total reject packets sent (CONTEXT_STATE with F bit on).

Total active channels.

Total inactive channels.

Number of available channels.

Per-channel counters—

Total compressed packets received.

Total synchronizing packets sent (CONTEXT_STATE with F bit off).

Reconstruction of the compressed packets, at decompression step 174 (FIG. 6) is a mirror image process to that shown in FIG. 8. When the compressed packet is a COMPRESSED_UDP packet, concentrator 32 generates the decompressed RTP packet to send over trunk 40 using the RTP channel information in UDP data 216, along with the remaining context data for the channel that is stored in the memory pool. The concentrator increments the IP ID by 1 if I=0, or by the number indicated in field 214 of the packet if I=1.

For a COMPRESSED_RTP packet, if M=S=T=I=1, and CC is non-zero, the CC field in the channel context is updated with the value in field 223 of packet 220, and the CSRC list in the context is replaced with the contents of field 228 in the packet. This new information is used in all reconstructed packets, beginning with the current one. Depending on the values of M, S, T and I (or of M′, S′, T′ and I′, if M=S=T=I=1), the remaining variable fields of the RTP packet are reconstructed, using constant increments or the special increments given in fields 214, 224 and 226. Header extension 230 and padding 234 are optionally added to the packet, the UDP length is recalculated, and the packet is sent out on trunk 40 as a standard RTP/UDP/IP packet.

As noted above, although the processes of channel creation and of compression and decompression of RTP packets are described with respect to packets transmitted from subscriber equipment, via transceiver 34, to concentrator 32 over power line 24, similar methods are used to create channels and to compress and decompress packets received by concentrator 32 from packet trunk 40 for transmission over the power line to transceiver 34. Furthermore, although for the sale of clarity, these processes are illustrated with reference to a single connection in the very simple PLC network 22 shown in FIG. 1, it will be understood that the methods exemplified by the preferred embodiments described herein may equally be applied in more complex PLC network topologies, with multiple RTP sessions going on simultaneously.

More generally speaking, while RTP/UDP/IP provides particularly fertile ground for creating connection-oriented sessions and performing header compression in a PLC network, the principles of the present invention may also be applied to other connectionless protocols, particularly real-time protocols, that are used in the PLC network environment. Furthermore, although preferred embodiments are described herein with specific reference to PLC networks, the principles of the present invention may also be applied, mutatis mutandis, to encapsulation and compression of packets transmitted over wireline and wireless networks of other types, particularly networks that, like PLC networks, have high noise and error rates.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
establishing a data link between first and second transceivers over an electric power line;
receiving a sequence of data packets for transmission over the data link, the sequence belonging to a session of a connectionless real-time network protocol;
responsive to a first packet in the sequence, establishing a reliable connection channel for the session over the data link between the first and second transceivers; and
transmitting the packets in the sequence from the first to the second transceiver over the reliable connection channel.

2. A method according to claim 1, wherein the packets comprise header information, and wherein transmitting the packets comprises compressing the header information in the packets transmitted using the channel from the first to the second transceiver.

3. A method according to claim 2, wherein establishing the reliable connection channel comprises storing context information with respect to the session at the first and second transceivers, and wherein compressing the header information comprises compressing the header information using the stored context information.

4. A method according to claim 3, wherein storing the context information comprises conveying the context information to the second transceiver along with a channel identifier in the first packet in the sequence, and wherein compressing the header information comprises inserting the channel identifier in the packets in the sequence following the first packet as a reference to the context information.

5. A method according to claim 4, and comprising reconstructing the compressed header information at the second transceiver using the stored context information referenced by the channel identifier.

6. A method according to claim 2, wherein compressing the header information comprises detecting changes in the header information in successive packets in the sequence, and encoding the changes.

7. A method according to claim 1, and comprising sending an acknowledgment from the second transceiver to the first transceiver responsive to at least some of the packets in the sequence transmitted by the first transceiver, thereby maintaining the reliable connection channel.

8. A method according to claim 7, wherein establishing the reliable connection channel comprises determining an acknowledgment interval that comprises a given number of the packets, and wherein sending the acknowledgment comprises sending the acknowledgment every time the given number of packets has been received at the second transceiver.

9. A method according to claim 8, wherein transmitting the packets comprises adding an error detection code at the first transceiver to one of the packets in the acknowledgment interval, and wherein sending the acknowledgment comprises checking the error detection code at the second transceiver, and indicating a result of the checking in the acknowledgment.

10. A method according to claim 7, wherein transmitting the packets comprises adding a channel sequence number to each of the packets, and wherein sending the acknowledgment comprises sending an indication from the second transceiver to the first transceiver when the channel sequence number of the packets received at the second transceiver deviates from a consecutive order.

11. A method according to claim 7, wherein establishing the reliable connection channel comprises sending a request from the first transceiver to the second transceiver to allocate a resource for the channel, and wherein sending the acknowledgment comprises indicating to the first transceiver whether or not the second transceiver has the resource available to open the channel.

12. A method according to any of claims 1-11, wherein the first and second transceivers comprise a subscriber transceiver in a subscriber premises and a concentrator, and wherein the electric power line is a part of a mains voltage power line network to which the subscriber transceiver and the concentrator are connected.

13. A method according to claim 12, wherein the subscriber transceiver is one of a plurality of such transceivers in multiple, respective subscriber premises connected to the power line network, and wherein the concentrator is coupled to link the plurality of the transceivers to a packet communication trunk.

14. A method according to claim 13, wherein receiving the sequence of the data packets comprises receiving a real-time data flow to be conveyed between the subscriber premises and a network server via the packet communication trunk.

15. A method according to claim 14, wherein receiving the real-time data flow comprises receiving telephony data, and wherein the network server comprises a telephony gateway, which is coupled to a public switched telephone network (PSTN).

16. A method according to claim 15, wherein receiving the telephony data comprises receiving data associated with a telephone call placed from one of the multiple subscriber premises connected to the power line network to another of the multiple subscriber premises, and wherein the telephony gateway is further configured to serve as a virtual exchange, so as to convey the telephony data from the one of the subscriber premises to the other without sending the data through the PSTN.

17. A method according to any of claims 1-11, wherein receiving the sequence of the data packets comprises receiving real-time multimedia data.

18. A method according to claim 17, wherein receiving the multimedia data comprises receiving video data.

19. A method according to claim 17, wherein receiving the multimedia data comprises receiving voice data.

20. A method according to claim 19, wherein receiving the voice data comprises coupling a telephone handset to one of the transceivers, and conveying the voice data as an analog audio signal between the one of the transceivers and the telephone handset.

21. A method according to claim 19, wherein receiving the voice data comprises coupling a personal computer to one of the transceivers, and conveying the data packets between the one of the transceivers and a voice application on the personal computer.

22. A method according to any of claims 1-11, wherein receiving the sequence of the data packets comprises receiving the packets in accordance with a Real-time Transfer Protocol (RTP).

23. Communication apparatus, comprising a first data transceiver, which is configured to establish a data link with a second data transceiver over an electric power line, such that upon receiving a sequence of data packets for transmission over the data link, the sequence belonging to a session of a connectionless real-time network protocol, the first data transceiver is adapted, responsive to a first packet in the sequence, to establish a reliable connection channel for the session over the data link with the second transceiver and to transmit the packets in the sequence to the second transceiver over the reliable connection channel.

24. Apparatus according to claim 23, wherein the packets comprise header information, and wherein the first data transceiver is adapted to compress the header information in the packets for transmission using the channel.

25. Apparatus according to claim 24, wherein to establish the reliable connection channel context information with respect to the session is stored at the first and second transceivers, and wherein the first data transceiver is adapted to compress the header information using the stored context information.

26. Apparatus according to claim 25, wherein the first transceiver is adapted to convey the context information to the second transceiver along with a channel identifier in the first packet in the sequence, and to insert the channel identifier in the packets in the sequence following the first packet as a reference to the context information.

27. Apparatus according to claim 26, wherein the compressed header information is reconstructed at the second transceiver using the stored context information referenced by the channel identifier.

28. Apparatus according to clam 24, wherein the first transceiver is adapted to compress the header information by detecting changes in the header information in successive packets in the sequence, and encoding the changes.

29. Apparatus according to claim 23, wherein tile first transceiver is adapted after establishing the reliable connection channel, to receive an acknowledgment from the second transceiver responsive to at least some of the packets in the sequence transmitted by the first transceiver, thereby maintaining the reliable connection channel.

30. Apparatus according to claim 29, wherein the first transceiver is adapted to instruct the second transceiver to send the acknowledgment every time a given number of packets making up a predetermined acknowledgment interval has been received at the second transceiver.

31. Apparatus according to claim 30, wherein the first transceiver is adapted to add all error detection code to one of the packets in the acknowledgment interval, and to receive from the second transceiver in the acknowledgment a result of checking the error detection code.

32. Apparatus according to claim 29, wherein the first transceiver is adapted to add a channel sequence number to each of the packets, and to receive an indication in the acknowledgment from the second transceiver when the channel sequence number of the packets received at the second transceiver deviates from a consecutive order.

33. Apparatus according to claim 29, wherein the first transceiver is adapted to send a request to the second transceiver to allocate a resource for the reliable connection channel, and to receive the acknowledgment indicating whether or not the second transceiver has the resource available to open the channel.

34. Apparatus according to any of claims 23-33 wherein the sequence of the data packets comprises real-time multimedia data

35. Apparatus according to claim 34, wherein the multimedia data comprise video data.

36. Apparatus according to claim 34, wherein the multimedia data comprise voice data.

37. Apparatus according to claim 36, wherein the first transceiver comprises a telephone adapter, which is configured to exchange the voice data in the form of analog audio signals to and from a telephone handset.

38. Apparatus according to claim 36, wherein the first transceiver comprises a computer communication port, which is configured to exchange the voice data in the form of voice packets to and from a voice application on the personal computer.

39. Apparatus according to any of claims 23-33, wherein the connectionless real-time protocol comprises a Real-time Transfer Protocol (RTP).

40. Apparatus according to any of claims 23- 33, wherein the first transceiver comprises one of a subscriber transceiver in a subscriber premises, and a concentrator, and wherein the electric power line is a part of a mains voltage power line network to which the subscriber transceiver and the concentrator are connected.

41. Communication apparatus, comprising:
a subscriber transceiver, for deployment in a subscriber premises, the subscriber transceiver being adapted to be coupled to an electric power line belonging to a mains voltage power line network; and
a concentrator, coupled to the power line network so as to convey data between the subscriber transceiver and a packet communication trunk the subscriber transceiver and the concentrator being configured to establish a data link therebetween over the electric power line, such that upon receiving a sequence of data packets for transmission over the data link, the sequence belonging to a session of a connectionless real-time network protocol, the subscriber transceiver and the concentrator are adapted, responsive to a first packet in the sequence, to establish a reliable connection channel for the session over the data link and to transmit the packets in the sequence from one to another over the reliable connection channel.

42. Apparatus according to claim 41, wherein the sequence of the data packets comprises a real-time data flow to be conveyed between the subscriber premises and a network server via the packet communication trunk.

43. Apparatus according to claim 42, wherein the real-time data flow comprises telephony data, and wherein the network server comprises a telephony gateway, which is coupled to a public switched telephone network (PSTN).

44. Apparatus according to any of claims 41-43, wherein the subscriber transceiver is one of a plurality of such transceivers in multiple, respective subscriber premises connected to the power line network, and wherein the concentrator is coupled to link all of the plurality of the transceivers to the packet communication trunk.

45. Apparatus according to claim 44, wherein the sequence of the data packets comprises telephony data associated with a telephone call placed from one of the multiple subscriber premises connected to the power line network to another of the multiple subscriber premises, and comprising a telephony gateway, coupled to the packet communication trunk, which is configured to serve as a virtual exchange, so as to convey the telephony data from the one of the subscriber premises to the other without sending the data through a public switched telephone network (PSTN).

46. Apparatus according to claim 45, wherein when the telephony gateway is further coupled to the PSTN so as to convey telephone communications between the PSTN and the multiple subscriber premises.
